(19) United States
(12) Patent Application Publication
(10) Pub. No.: US 2010/0106458 A1
(43) Pub. Date: Apr. 29, 2010

(54) COMPUTER PROGRAM AND METHOD FOR DETECTING AND PREDICTING VALVE FAILURE IN A RECIPROCATING COMPRESSOR

(76) Inventors: Ming C. Leu, Rolla, MO (US); Jagannathan Sarangapani, Rolla, MO (US); Raghuram Puthall Ramesh, Houston, TX (US)

Correspondence Address: HOVEY WILLIAMS LLP, 10801 Mastin Blvd., Suite 1000, Overland Park, KS, 66210, US

(21) Appl. No.: 12/259,772

(22) Filed: Oct. 28, 2008

(51) Int. Cl. G06F 17/18

(52) U.S. Cl. 702/181

(57) ABSTRACT

Embodiments of the present invention provide a method implemented by a computer program for detecting and identifying valve failure in a reciprocating compressor and further for predicting valve failure in the compressor. Embodiments of the present invention detect and predict the valve failure using wavelet analysis, logistic regression, and neural networks. A pressure signal from the valve of the reciprocating compressor presents a non-stationary waveform from which features can be extracted using wavelet packet decomposition. The extracted features, along with temperature data for the valve, are used to train a logistic regression model to classify defective and normal operation of the valve. The wavelet features extracted from the pressure signal are also used to train a neural network model to predict to predict the future trend of the pressure signal of the system, which is used as an indicator for performance assessment and for root cause detection of the compressor valve failures.

### BACKGROUND

1. Field

The present invention relates to computer programs and method for detecting and predicting valve failure in complex machinery, such as a reciprocating compressor. More particularly, the invention relates to a computer program and a method for analyzing standard, measurable parameters of a compressor system, such as pressure, temperature, and vibration, and extracting features from the parameters that best indicate a health of a compression process of the compressor system or a component of the compressor.

2. Description of the Related Art

Complex machinery used in manufacturing processes is, like any other machinery, subject to breaking down and failure. Because the complex machine is often critical to the manufacturing process, and further because there is often not a back-up machine that can be used while the broken machine is being prepared, the manufacturing process must be aborted while repair on the broken machine is performed. As can be appreciated, loss of a complex machine due to repair in a manufacturing environment often leads to other problems beyond just the need to repair the machine. For example, if a machine central to the manufacturing process is being repaired, then other machines may be forced to be idle, personnel may not be optimally used, and goods partway through the manufacturing process may be compromised due to the timing of the breakdown and the inability to complete the manufacturing process.

To address these concerns, a field of maintenance referred to as “condition-based monitoring” (“CBM”) has emerged. Instead of performing corrective maintenance once a failure arises, or expensive and possibly needless preventative maintenance to ward off potential failures, CBM attempts to detect and/or predict upcoming failures before they result in required repair of machine use at inopportune times. Although in theory, CBM is an advantageous tool for monitoring the health of a machine, in operation, CBM suffers from an overly simplified analysis of information extracted from the machine.

For example, many CBM methods for complex compressor systems monitor one or more various parameters of the system, including vibration of the system, temperature of the system, and certain pressure levels. From known satisfactory levels of each parameter, the CBM method will alert an engineer if any one of these parameters is outside a normal range, or if a parameter has exhibited certain behavior outside of normal practice. This CBM method is sufficient for basic detection and prediction but lacks the sophistication necessary to determine problems should the change in parameter be due to something other than system failure.

With respect to reciprocating compressors, which are commonly used in industrial applications, maintenance of the compressors is very costly. Reciprocating compressors, in particular, have many moving parts that are subject to extreme wear and often break down, resulting in a loss of time and money. It is an estimated that unscheduled downtime of compressors on critical systems can cause losses of up to $100,000 per day. The most common failure in a reciprocating compressor is valve failure. Accordingly, there is a need for a prognostic method that can proactively predict the impending failures of valve components, so that scheduled and reactive maintenance on the compressors can be eliminated, thereby increasing the throughput of the system and reducing the lifecycle costs.

### SUMMARY

The present invention solves the above-described problems and provides a distinct advance in the art of condition-based monitoring for a reciprocating compressor. More particularly, the present invention provides a method and a computer program operable to predict valve failure in a reciprocating compressor and further operable to detect and provide a root cause failure for valve failure in the compressor. Embodiments of the present invention are operable to detect and predict valve failures using wavelet analysis, logistic regression, and neural networks.

As can be appreciated, a pressure signal from a reciprocating compressor is a non stationary waveform. Features from the signal can be extracted using wavelet packet decomposition. In one embodiment of the present invention, the extracted features, along with temperature date for the reciprocating compressor, are used to train a logistic regression model to classify defective and normal operation of a valve. The model, for a given set of input, will give the probability of the input belonging to either a normal or defective signature group. Hence, the logistic regression model is used as an indicator of system health.

In another embodiment of the present invention, the wavelet features extracted from the pressure signal are used to train a neural network model to predict the future trend of the pressure signal of the system, which is used as an indicator for performance assessment and for root cause detection of the compressor valve failures.

The embodiments of the present invention can provide early warning for failure of the system and indicate impending failure of system components. The method of embodiments of the present invention is implemented via the computer program of the present invention to derive operational characteristics of a component of the reciprocating compressor, such as the pressure of the compressor, without the use of expensive sensors and by extending the most frequently used sensors for condition monitoring.

These and other important aspects of the present invention are described more fully in the detailed description below.

### BRIEF DESCRIPTION OF THE DRAWING FIGURES

Embodiments of the present invention are described in detail below with reference to the attached drawing figures, wherein:

FIG. 1A is a flowchart illustrating a method of predicting valve failure in a reciprocating compressor;

FIG. 1B is a flowchart illustrating a method of detecting valve failure in the reciprocating compressor and determining a root cause of the valve failure;

FIG. 2 is a side view through a vertical cross-section of the reciprocating compressor;

FIG. 3 is a side view through a vertical cross-section of the reciprocating compressor and further illustrating a location of common sensors used with the reciprocating compressor and a measurement of the sensors;

FIG. 4 is a pressure-volume diagram;

FIG. 5 is a block diagram illustrating the components of the reciprocating compressor and computer program of the present invention;

FIG. 6 is a cause-and-effect diagram for common valve failures in the reciprocating compressor;

FIG. 7 is a diagram illustrating an architecture of an Elman neural network;

FIG. 8 is a flowchart for application of the method of an embodiment of the present invention operable to predict valve failure in the reciprocating compressor;

FIG. 9 is a chart illustrating a confidence value for certain test data used by Applicants for determining the efficacy of embodiments of the present invention;

FIG. 10 is a chart illustrating a confidence value for a first valve performance using a logistic regression of embodiments of the present invention;

FIG. 11 is a chart illustrating a confidence value for a second for a second valve performance using a logistic regression of embodiments of the present invention;

FIG. 12 is a chart illustrating actual and predicted wavelet features using a neural network of embodiments of the present invention;

FIG. 13 is a chart illustrating the actual and predicted wavelet features for the first one hundred minutes of operation of the reciprocating compressor;

FIG. 14 is a chart illustrating the actual and predicted wavelet features for the second one hundred minutes of operation of the reciprocating compressor;

FIG. 15 is a chart comparing the predictions given by the neural network of embodiments of the present invention with the predictions of a neural network using only a gradient descent algorithm; and

FIG. 16 is a chart illustrating an error in prediction between the actual and predicted values of energy trends for the neural network of embodiments of the present invention and the predictions of a neural network using only a gradient descent algorithm.

The drawing figures do not limit the present invention to the specific embodiments disclosed and described herein. The drawings are not necessarily to scale, emphasis instead being placed upon clearly illustrating the principles of the invention.

### DETAILED DESCRIPTION

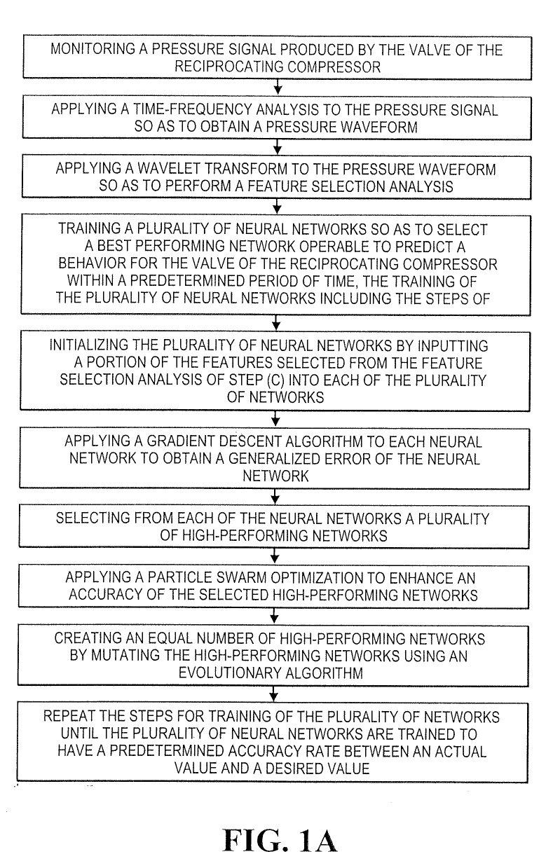

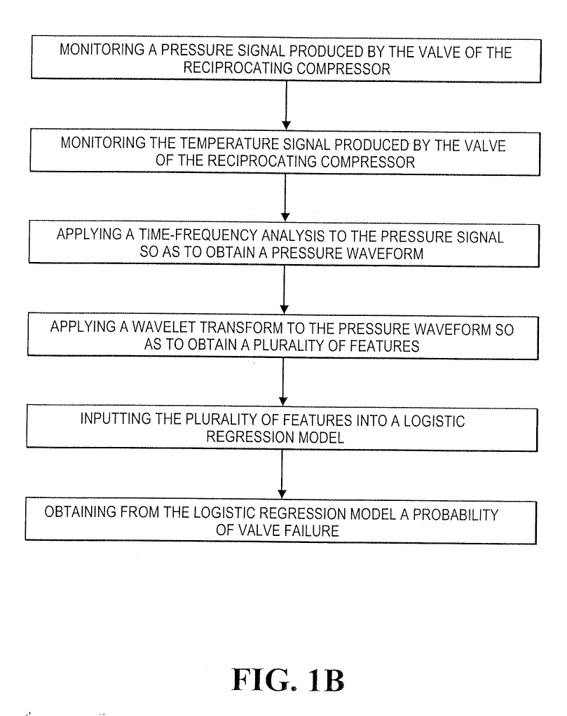

Turning now to the drawing figures, and particularly FIG. 1, a computer program and a method in accordance with embodiments of the present invention is depicted. The computer program and method are operable to detect and/or predict in complex machinery, such as a reciprocating compressor 10, failure of a valve. The method of embodiments of the present invention is implemented via the computer program of embodiments of the present invention. As set forth in FIG. 1A, in embodiments of the present invention that predict valve failure, the method comprises the steps of: (a) monitoring a pressure signal produced by the valve of the reciprocating compressor; (b) applying a time-frequency analysis to the pressure signal so as to obtain a pressure waveform; (c) applying a wavelet transform to the pressure waveform so as to perform a feature selection analysis; and (d) training a plurality of neural networks so as to select a best performing network operable to predict a behavior for the valve of the reciprocating compressor within a predetermined period of time, the training of the plurality of neural networks including the steps of (d1) initializing the plurality of neural networks by inputting a portion of the features selected from the feature selection analysis of step (c) into each of the plurality of networks, (d2) applying a gradient descent algorithm to each neural network to obtain a generalized error of the neural network, (d3) selecting from each of the neural networks a plurality of high-performing networks, (d4) applying a particle swarm optimization to enhance an accuracy of the selected high-performing networks, (d5) creating an equal number of high-performing networks by mutating the high-performing networks selected from step (d3) using an evolutionary algorithm, and (d6) repeating steps (d1)-(d5) until the plurality of neural networks are trained to have a predetermined accuracy rate between an actual value and a desired value.

As set forth in FIG. 1B, in other embodiments of the present invention that detect valve failure and determine a root cause of the valve failure, the method comprises the steps of: (a) monitoring the pressure signal produced by the valve of the reciprocating compressor; (b) monitoring the temperature signal produced by the valve of the reciprocating compressor; (c) applying a time-frequency analysis to the pressure signal so as to obtain a pressure waveform; (d) applying a wavelet transform to the pressure waveform so as to obtain a plurality of features; (e) inputting the plurality of features into a logistic regression model; and (f) obtaining from the logistic regression model a probability of valve failure.

### Reciprocating Compressor Systems

Compressors are primarily used for producing a gas at a higher pressure than the ambient condition. Compressors have a wide variety of applications and vary in size from a few feet to tens of feet in diameter. Depending on the type, compressors increase the pressure in different ways. They can be divided into four general groups: rotary, reciprocating, centrifugal, and axial. In rotary and reciprocating compressors 10, shaft work is used to reduce the volume of gas and increase the gas pressure. In axial and centrifugal compressors, the fluid is first accelerated through moving blades and then passed through a nozzle.

Reciprocating compressors 10 are the most common type of compressors found in industrial applications. A reciprocating compressor 10 horsepower is approximately three times that of centrifugal compressors. Reciprocating compressors 10 offer a broad range of capacity control and extremely high compression ratios, irrespective of gas molecular weight. This is advantageous in certain process industries, such as hydrogen gas compression and natural gas transport industry.

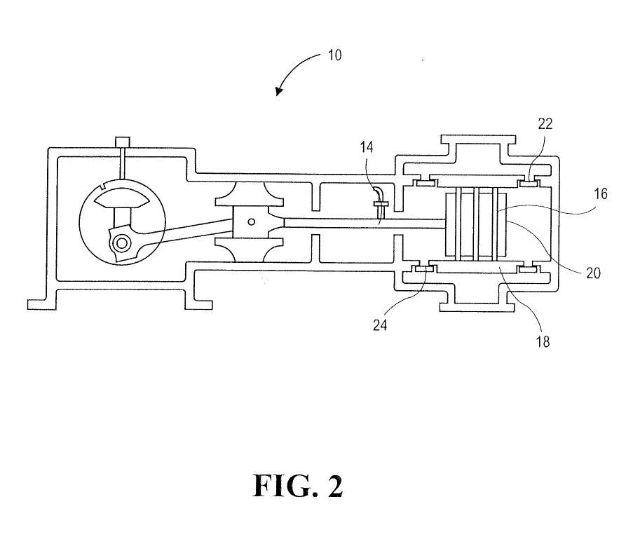

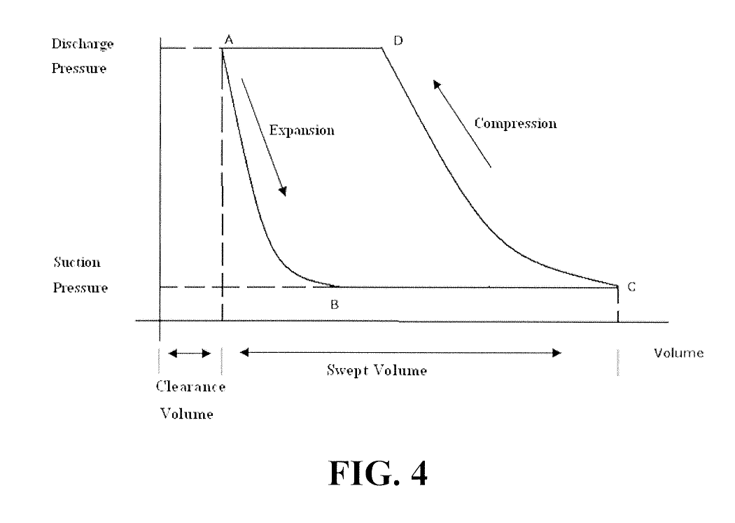

As illustrated in FIG. 2, reciprocating compressor 10 has a piston-cylinder arrangement. A piston 14, including a piston head 16, reciprocates within a cylinder 18, including a cylinder head 20, to produce gasses at higher temperature and pressure. A suction valve 22 and a discharge valve 24 controls the flow of the gas inside and outside the cylinder 18. The dynamics of the reciprocating process in the compressor 10 are explained by a Pressure-Volume (PV) diagram illustrated in FIG. 4.

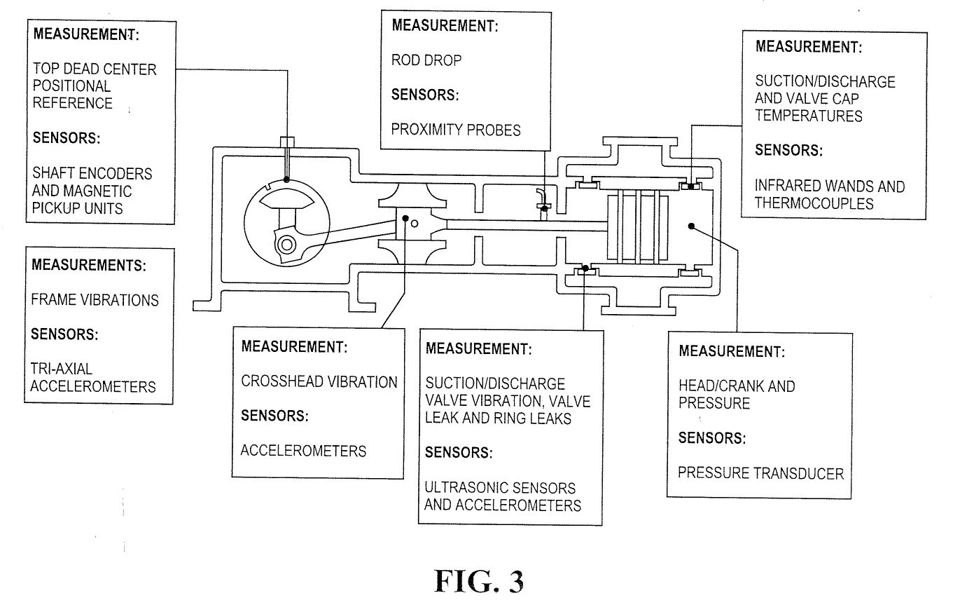

As illustrated in FIG. 4, at point A, also known as top dead center (“TDC”), both suction and discharge valves 22,24 are closed. During an expansion stroke, the piston 14 moves from TDC to the bottom dead center (“BDC”), indicated by point B in FIG. 4, thereby increasing the volume of gas that originally occupied the volume between the piston head 16 and the cylinder head 20, also known as the clearance volume and as illustrated in FIG. 3. The increase in volume reduces the cylinder's 18 internal pressure. As the piston 14 reaches point B, internal pressure within the cylinder 18 is equal to the suction line pressure. A small additional piston 14 movement is enough to reduce the internal pressure of the cylinder 18 below the suction line pressure, causing the suction valve 22 to open.

As the piston moves from point B to point C, the suction line gas at a higher pressure than the cylinder's 18 internal pressure is drawn inside the cylinder 18. The portion of the total cylinder volume occupied by the admitted gas is called the suction volume. At point C, the piston 14 begins to move in the opposite direction, towards the TDC. As this movement begins, the piston 14 reduces the volume of gas contained in the cylinder 18, increasing its pressure and forcing the suction valve 22 to close. After the suction valve 22 closes, the original clearance volume gas and the gas admitted during the suction cycle are reduced in volume by the piston 14 movement. Consequently, the cylinder's 18 internal pressure increases until reaching the discharge line pressure in point D. A small additional piston 14 movement is enough to raise the cylinder's 18 internal pressure above the discharge line pressure causing the discharge valve 24 to open. From point D to point A, the gas in the cylinder 18 at pressures exceeding the discharge line is discharged. The volume of gas discharged is called discharge volume. The theoretical PV diagram, when superimposed on the actual diagram, supplies compressor diagnostic information.

Because of manufacturing and assembly tolerances, reciprocating compressors 10 always have some clearance volume. Because there is some gas remaining in the clearance volume at the end of the entire discharge stroke (swept volume), this remaining gas will expand during the suction stroke. The ratio between the suction volume and the swept volume is called suction volumetric efficiency. In a similar manner, only part of the piston stroke is used to discharge gas. The ratio between the discharge volume and the swept volume is called discharge volumetric efficiency.

Volumetric efficiency has to be maintained high for good compressor performance. The volumetric efficiency can be monitored by the PV diagram, but this calls for using high end instrumentation on the system. The operating conditions for most of the times are very extreme, and online monitoring using sensors that can function at these extreme conditions is not economical. Hence, there is a need for a scheme that utilizes relatively inexpensive sensors to analyze the performance of the compressor system and its components.

### Hardware for Implementation of the Computer Program and Method of Embodiments of the Present Invention

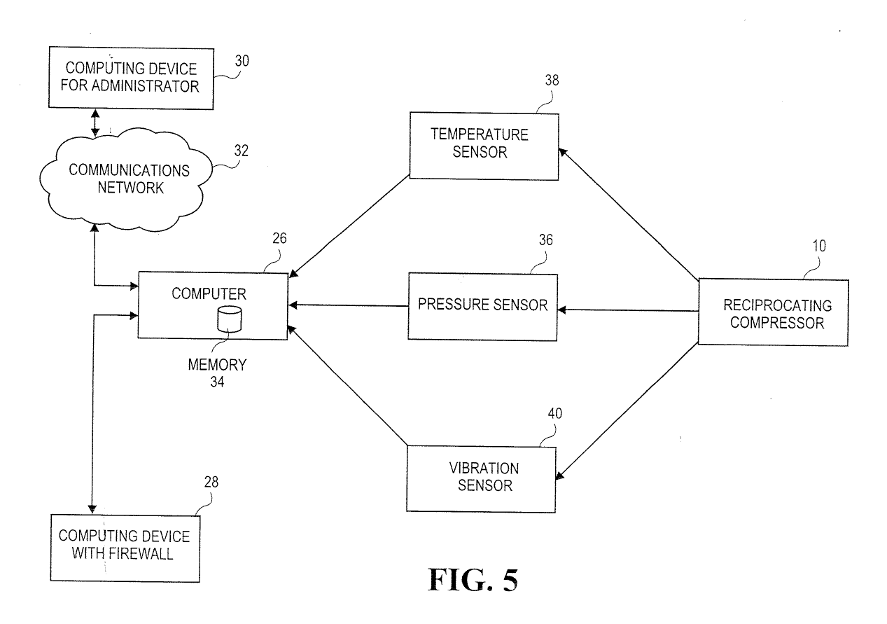

The present invention can be implemented in hardware, software, firmware, or a combination thereof. In a preferred embodiment, however, the invention is implemented with a computer program that can be accessed by a computer 26, as illustrated in FIG. 5. The computer 26 may be accessible via a communications network (not shown). The computer program and computer 26 illustrated and described herein are merely examples of a program and equipment that may be used to implement embodiments of the present invention and may be replaced with other software and computer equipment without departing from the scope of the invention.

The computer 26 serves as a repository for data and programs used to implement certain aspects of the present invention as described in more detail below. The computer 26 may be any computing device such as a network computer running Windows NT, Novel Netware, Unix, or any other network operating system. The computer 26 may be connected to a computing device 28 that serves as a firewall to prevent tampering with information stored on or accessible by the computer 26 and to a computing device 30 operated by an administrator of the computer 26 via another communications network 32.

The computer 26 and computing devices 28,30 may include personal computers, such as those manufactured and sold by Dell, Compaq, Gateway, or any other computer manufacturer, handheld personal assistants such as those manufactured and sold by Palm or Pilot, or any other type of well-known computing device.

The computer program of embodiments of the present invention is stored in or on computer-readable medium 34 residing on or accessible by the computer 26 for instructing the computer 26 to execute certain code segments of the computer program. As such, embodiments of the computer program of the present invention comprise an ordered listing of executable instructions for implementing logical functions in the computer 26 and computing devices 28,30 coupled with the computer 26. The computer program can be embodied in any computer-readable medium 34 for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium 34” can be any means that can contain, store, communicate, propagate, or transport the program for use by or in connection with the instruction execution system, apparatus, or device. The computer-readable medium 34 can be, for example, but not limited to, an electronic, magnetic, optical, electromagnetic, infrared, or semi-conductor system, apparatus, device, or propagation medium. More specific, although not inclusive, examples of the computer-readable medium 34 would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The computer-readable medium 34 could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The flow chart of FIG. 1 shows the functionality and operation of a preferred implementation of the present invention in more detail. In this regard, some of the blocks of the flow chart may represent a module segment or portion of code of the computer program of embodiments of the present invention that comprises one or more executable instructions for implementing the specified logical function or functions. In some alternative implementations, the functions noted in the various blocks may occur out of the order depicted in FIG. 1. For example, two blocks shown in succession in FIG. 1 may in fact be executed substantially concurrently, or the blocks may sometimes be executed in the reverse order depending upon the functionality involved.

### Feature Extraction

A procedure for extracting useful information from raw data signals, such as the pressure, temperature, and vibration of the reciprocating compressor system 10 at a particular time, is known as feature extraction. The pressure, temperature, and vibration relating to the valve of the reciprocating compressor 10 can be sensed and monitored using well-known pressure, temperature, and vibration sensors 36,38,40. As illustrated in FIG. 5, the computer program for implementing the method of embodiments of the present invention monitors known parameters of the reciprocating compressor system 10, such as the pressure, temperature, and vibration, to obtain the raw data signal, and then analyzes the signal to detect and predict system failure. Sensors 36,38,40 are operably connected to the reciprocating compressor 10 and the computer 26 so as to input the raw data signal into the computer program, as described in more detail below.

Instrumentation on a Testing Platform

In order to test the efficacy of the present invention, Applicants set up a testing platform to study the three most prominent defects in the reciprocating compressor 10, namely, valve failure, piston ring failure, and rider band failure, and to sense and monitor piston/cylinder vibrations. As noted above, the pressure and temperature sensors 36,38, in conjunction with embodiments of the present invention, identify the effect of a component failure on the reciprocating compressor's 10 performance. By classifying the changes in performance a component failure has on the system performance, a system model was developed that monitored the system parameters but still effectively deduced component failures based on the trend of the parameters.

An overview of possible instrumentation on the reciprocating compressor 10 used to provide a comprehensive assessment of system health is illustrated in FIG. 3. The instrumentation includes encoders, proximity sensors, thermocouples, accelerometers, and other types of instruments. The following table also provides a listing of sensors and measurements embodiments of the present invention use in detecting valve failures, piston ring failures, and piston-cylinder vibrations.

Listings of Instrumentation for Three Types of Reciprocating Compressor Failures

| | | Piston ring and Rider | Piston/Cylinder |
|---|---|---|---|
| Defects | Valve failure | band failure/wear | vibrations |
| Sensors and | Thermocouples and | Proximity and eddy | Accelerometers |
| Measurements | Resistance Temperature | current sensors to | mounted on the |
| | Detectors (RTD) to measure | measure piston rod | compressor |
| | the valve cap | Drop. | cylinder |
| | and suction/Discharge gas | Pressure | and frame. |
| | temperatures. | transducers to | Piezo-electric |
| | Pressure transducers to | measure the | sensors |
| | measure the cylinder and | cylinder pressures. | mounted on the |
| | suction/Discharge gas | Thermocouples and | compressor |
| | pressures. | RTDs to measure | cylinder |
| | Displacement Sensors, | the valve cap and | and frame. |
| | such as fiber optic sensors, to | Suction - Discharge | Ultrasonic |
| | measure the displacement of | gas temperatures. | sensors |
| | the moving element of the | | mounted on |
| | valve. | | compressor |
| | Encoders on the crank to | | frame. |
| | provide relative position of | | |
| | piston in the cylinder. | | |
| | Accelerometers mounted | | |
| | on valve caps to detect | | |
| | change in vibration pattern as | | |
| | the valve plate impact | | |
| | velocity increases. | | |

As part of the testing of the present invention, Applicants installed pressure and temperature sensors 36,38 on the inlet and outlet of each of the cylinders 18 in order to sense any change or variation in pressure and temperature signatures due to failure of valves. The data acquisition was done at every fifteen (15) minutes, and data was collected for one second at a sampling rate of one thousand (1000) points per second for the pressure and magnetic pickup sensors and one (1) point per second for temperature sensors. In order to force the valve system into failure so as to speed up the testing process, accelerated failure tests were initiated, the results of which will be discussed in detail below.

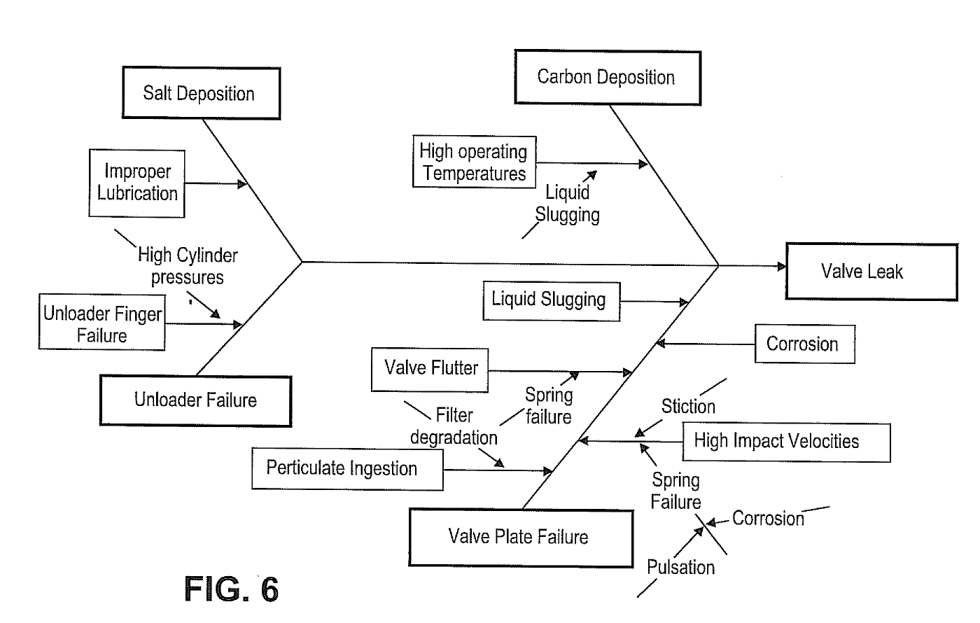

In order to understand the factors that cause failures on the valves, Applicants developed a cause-and-effect relationship for the valves of the reciprocating compressor 10. The model was helpful to realize the dependency of the failure modes on system parameters. FIG. 6 illustrates the cause-and-effect diagram for a valve failure, namely a valve leak.

As can be seen in FIG. 6, the cause-and-effect relationship indicates that spring and valve plate failures are caused mainly by stiction and spring failure. This leads to high impact velocities, which in turn results in high impact forces on the plate and spring elements. Hence, Applicants induced plate failures by creating conditions favorable to high impact velocities on the plate. In particular, Applicants introduced water and sand into the inlet cylinder during compression operation.

In order to induce stiction of the valve plate, a film of lubricant was applied to the valve seat. The film lubricant holds on to the valve plate by its adhesive property that increases the impact force on the plate when the adhesive force is overcome. The effect of accelerated tests performed by the Applicants was failure of the valve plate and spring.

Pressure and Temperature Waveform

As described above, for reciprocating compressors 10 the pressure and temperature undergo a cyclical change due to the reciprocating nature of the process. The frequency of the change in the pressure and temperature, i.e., the cycle of the pressure and temperature, is controlled by the speed of the reciprocating piston 14, which is run by the compressor's motor. The frequency of the pressure and temperature over time produces separate pressure and temperature waveforms. If a valve component of the system fails, this directly affects the waveforms, as the waveforms are a direct result of the natural frequency of the system. Thus, embodiments of the present invention analyze changes in the frequency of the pressure or temperature, i.e., changes in the pressure and temperature waveforms, to determine and predict failure of a valve component and causes for the failure.

Once the empirical pressure and temperature waveforms are obtained, they must be analyzed in a particular domain, such as time and/or frequency. Although waveforms can be analyzed in the time domain or the frequency domain, it is advantageous to analyze in the time-frequency domain, which investigates waveform signals in both the time and the frequency domains. Time-frequency analyses use time-frequency distributions, which represent the energy or power of waveform signals in two-dimensional functions of both time and frequency to better reveal fault patterns for more accurate diagnostics. To detect and predict failures in the reciprocating compressor system 10, the pressure waveform resulting from ordinary valve movement is analyzed in the time-frequency domain for effective identification of failure patterns and general diagnostics.

Embodiments of the present invention provide two different but related analyses. One embodiment of the present invention determines when the compressor system is experiencing a failure, and the root cause of the failure, using a logistic regression function. Information inputted into the function is obtained using wavelet transforms, described below.

Another embodiment of the present invention uses information obtained from the wavelet transforms and inputted into a neural network to predict upcoming valve failure before a catastrophic failure happens. As can be appreciated, embodiments of the present invention can be used alone or in combination to predict and/or detect valve failure. Because both detection and prediction of valve failure relies on decomposing the raw pressure signal of the valve using a wavelet transform, such decomposition method is described below and applied to both the detection (logistical regression function) and prediction (neural network) analyses. Note that the temperature signal of the valve is only analyzed for the logistic regression function described below.

### Signal Decomposition Using Wavelet Transforms

To analyze the pressure waveform, also referred to herein as a signal, the waveform is decomposed using a wavelet transformation. As is well known in the art, mathematical transformations are often applied to raw data signals to obtain additional information regarding the signal that is not otherwise known from just the raw data. A wavelet transformation, also referred to as a wavelet packet transform (“WPT”) is a type of mathematical transformation that can be applied to a signal to obtain additional information regarding the signal.

A WPT is represented by a wavelet packet function, or simply a “wavelet packet,” which is represented by the following function: Ψ_{j,k}ⁿ(t), where integers n, j, and k are the modulation, the scale, and the translation parameters, respectively, as provided in Equation (1) below.

The parameter k dictates the translation in time. It is related to the portion of the signal being analyzed, referred to as the “window,” as the window is shifted through the signal. The parameter k corresponds to time information in the transform domain.

The parameter j is the scale parameter, where j>0 is a continuous variable. Depending on the dilation parameter ‘j’, the wavelet function dilates or contracts in time, causing the corresponding contraction or dilation in the frequency domain. When ‘j’ is large (j>1), the basis function becomes a stretched version of the wavelet packet function (j=1) and demonstrates a low-frequency characteristic. When ‘j’ is small (j<1), this basis function is a contracted version of the wavelet packet function and demonstrates a high-frequency characteristic.

Thus, for fixed values of j and k, the wavelet packet function, Ψ_{j,k}ⁿ, analyzes the fluctuations of the signal roughly around the position ‘2^{j}.k’, at the scale 2^{j} and at various frequencies for the different admissible values of the last parameter n.

Ψ_{j,k}ⁿ(t)=2^{j/2}Ψⁿ(2^{j}t−k) n=1,2, . . . (1)

A decomposed wavelet packet component signal fⱼⁿ(t) can be expressed by a linear combination of wavelet packet functions as given below:

$${f}_{j}^{n} ( t ) = {\sum }_{k = - ∞}^{∞} {c}_{j , k}^{n} {Ψ}_{j , k}^{n} ( t ) \qquad ( 2 )$$

Wavelet packet coefficients c_{j,k}ⁿ can then be obtained from

$${c}_{j , k}^{n} = {\int }_{- ∞}^{∞} f ( t ) {Ψ}_{j , k}^{n} ( t ) d t \qquad ( 3 )$$

Often, direct assessment of all wavelet packet coefficients leads to inaccurate diagnostics. This is because any dynamical system 10 inherently includes some information outside the norm. Thus, applied to a reciprocating compressor system, some of the wavelet packets will contain information outside normal operating conditions of the system 10. The method assumes that information outside normal operating conditions that provides a relatively small, if any, assistance to accurate modeling of the system. Thus, the wavelet packets that yield the best or most accurate information regarding the signal, otherwise referred to as the discriminatory information, are included in the analysis, and the wavelet packets providing little information are filtered out or otherwise excluded form the analysis. In embodiments of the present invention, the wavelet packet node energy, e_{j,n}, is used for extracting the prominent features and is defined as follows:

$${e}_{j , n} = {\sum }_{k} {( {c}_{j , k}^{n} )}^{2} \qquad ( 4 )$$

The wavelet packet energy measures the energy of the signal contained in some specific frequency band indexed by parameters j and k.

A process known as feature selection is then performed. Similar to the wavelet packet node energy analysis, those features of the wavelet packet that contain information outside normal operating conditions of the system are discarded from the analysis. To determine what features should be discarded, the feature components are ranked according to a criterion function. Once the ranking is known, a feature subset including the features with the discriminatory information can then be selected by choosing those features with a higher criterion function value. Application of this analysis assists in reducing the dimension features required to be analyzed.

Applicants have found that Fisher's criterion, provided in Equation 6, is suitable for embodiments of the present invention.

A discriminatory power is determined using Equation (6). The features are ranked as

J(f₁)≧J(f₂)≧ . . . ≧j(fₙ₋₁)≧J(fₙ) (5)

where J(•) is a criterion function for measuring the discriminatory power of a specific feature component. The criterion function (Fisher's criterion) is defined as

$${J}_{{f}_{l}} ( i , m ) = \frac{{\vert {μ}_{i , {f}_{l}} - {μ}_{m , {f}_{l}} \vert}^{2}}{{σ}_{i , {f}_{l}}^{2} + {σ}_{m , {f}_{l}}^{2}} \qquad ( 6 )$$

where μ_{i,f}_{ₗ} and μ_{m,f}_{ₗ} are the mean values of the l^{th} feature, fₗ, for class i and m, and σ_{i,f}_{ₗ} and σ_{m,f}_{ₗ} are the variance of the l^{th} feature, fₗ, for class i and m correspondingly. The feature that is most discriminatory can be selected from the available features that have larger criterion function values. The features, {fₗ|l=1,2, . . . ,n}, once identified, can be ranked from the features showing the highest discriminatory effect to the features showing the least. The features are then used to train a logistic regression model, as discussed below, and to enhance the generalization capability of the diagnostic process using a neural network.

### Failure Prognostics Using a Neural Network Model

Embodiments of the present invention are operable to predict the performance of the reciprocating compressor 10 and indicate upcoming failure of certain components using the neural network. In particular, the neural network of embodiments of the present invention can predict the trend of wavelet features, as developed above.

Prediction methods can be developed either by studying the underlying physics and laws of a system, and the process the system is going through, or by observing empirical regularities in the signal. Though the physics-based approach yields powerful results, it is not trivial to understand the underlying laws due to the highly complex nature and nonlinearity associated with the process. In contrast, empirical-based methods are easier to devise and implement, but unfortunately, they are not able to recognize failure problems due to noise in the signal.

Neural networks are a compromise to either of the above approaches. Neural networks are usually somewhat accurate function approximators. They have the property of recognizing rather arbitrary dynamical systems, and they have good robustness to noise and implementation, i.e., small changes in the network will not affect the computation in a finite time interval.

Recurrent Neural Networks

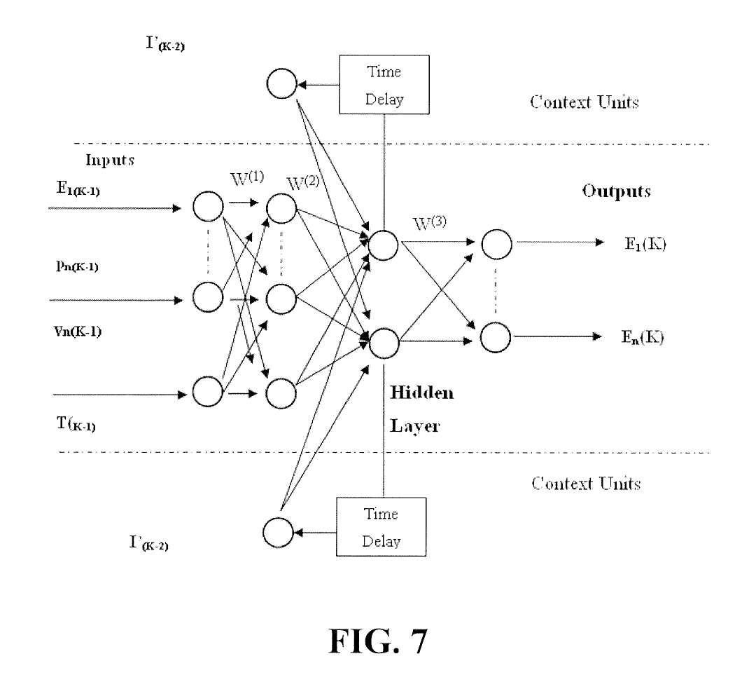

Neural networks with the ability to store historic data, also referred to herein as recurrent neural networks, are operable to forecast events because of the capability of storing the previous states of the system through recurrent connections. An Elman recurrent neural network is known to show a promising potential for prediction of polymer product quality, dissolution profiles in pharmaceutical product development, and chaotic time series. Embodiments of the present invention apply the Elman recurrent neural network for the prediction of the performance trend of the valve system. The architecture of an Elman network is illustrated in FIG. 7.

Referring to FIG. 7, pₙ represents a matrix of peak pressures per cycle of compression of the reciprocating compressor 10, T represents a temperature of each cycle, and Eₙ represents a matrix of wavelet energy features. The parameters pₙ, T, and Eₙ (obtained from the wavelet transform described above) are the inputs to the network. E₁, E₂, . . . , Eₙ are the wavelet energies and are the outputs that the network will be trained to approximate. The context layer holds the historical data represented by I′. W⁽ⁱ⁾ represents the weight matrix for the i^{th} layer, and K represents the instantaneous time for which the data is applicable. Thus, the neural network constructed for embodiments of the present invention has an input layer, two hidden layers, and an output layer.

Training of the Neural Network

To predict valve behavior of the reciprocating compressor 10, the neural network must first be trained to recognize or approximate a time series function of the wavelet energy, i.e., what is happening with respect to the valve at a particular time. As can be appreciated, the time series function of the wavelet energy is a representation of valve performance.

An algorithm that can be used to accomplish the task of network training is the gradient descent learning algorithm, discussed in more detail below. It adapts the weights of the network by comparing the desired and actual values for a given input into the network. The network consequently forms a multi-dimensional error surface for a given set of inputs and desired values. This leads to a major drawback of this method because the error surface comprises numerous local minima. The gradient descent algorithm tends to move the solution space for the network weights towards the local minima. Often, the solution space may get locked in local minima of the error surface. This may lead to a poor performance of the neural network and poor prediction.

In order to solve the problem of local minima, embodiments of the present invention train the neural network with a hybrid algorithm of the gradient descent algorithm, Particle Swarm Optimization (“PSO”), and an Evolutionary Algorithm (“EA”). In this hybrid algorithm, a plurality of ten similar recurrent neural networks is randomly initialized, and each network, referred to as a particle, is trained individually with the given input and desired data. By applying a selection operation in PSO, the particles with the best performance are used as inputs for the next training generation, i.e., the particles with the best performance are copied to the next generation. Therefore, PSO always applies the best performing particles to the next generation of training of the network.

An EA is then coupled with the PSO in order to enhance the performance of the training algorithm. EAs are search and optimization techniques based on natural processes and often produce good results in training recurrent neural networks.

The hybrid algorithm of embodiments of the present invention combines the gradient descent algorithm, PSO, and the EA to obtain a method having the best features of each of the individual algorithms. While PSO is driven by social and cognitive adaptation of knowledge, which means that the weights of the neural networks are adapted based on the best performing particle in the population of networks, the EA is driven by principles of evolution, wherein the weights of the network are mutated to move the search to a different area of the solution space, thereby facilitating better global search capability.

Gradient Descent Algorithm

The gradient descent algorithm, known as a back propagation technique, trains the neural network based on a steepest descent approach applied to the minimization of the energy function E_{q}. The energy function represents the instantaneous error, and the training process involves computing the input covariance matrix and the cross correlation vector, estimated by Equations (7) and (8).

The energy function to be minimized is given by

$${E}_{q} = \frac{1}{2} {( {d}_{q} - {x}_{out}^{( 3 )} )}^{T} ( {d}_{q} - {x}_{out}^{( 3 )} ) \qquad ( 7 )$$

where d_{q} represents the desired network output for the q^{th} pattern, and xₒᵤₜ⁽³⁾ is the actual output of the recurrent network in FIG. 7 given by

xₒᵤₜ⁽³⁾=tan sig[W⁽³⁾×xₒᵤₜ⁽²⁾]

xₒᵤₜ⁽²⁾=tan sig[W⁽²⁾×xₒᵤₜ⁽¹⁾]

xₒᵤₜ⁽¹⁾=tan sig[W⁽¹⁾×inp] (8)

where xₒᵤₜ⁽ⁱ⁾, for i=1,2,3, represents the output of i^{th} layer; W⁽ⁱ⁾, for i=1,2,3, represents the weight matrix for the i^{th} layer; inp=input matrix, which in this case would be a matrix of normalized historical energy trend, peak pressure per cycle, valve timing per cycle, and temperature; tan sig equals the neuronal activation function tangential sigmoid.

The function tan sig is given by

$$tan sig ( x ) = \frac{{e}^{x} - {e}^{- x}}{{e}^{x} + {e}^{- x}} \qquad ( 9 )$$

The saturating limits of the tan sig function have a bipolar range. The negative and positive ranges of the function have analytical benefits in terms of training the neural network model.

The rule for updating the weights of the defined network can be generalized as

Wⱼₛ⁽ⁱ⁾(k+1)=Wⱼₛ⁽ⁱ⁾(k)+μ⁽ⁱ⁾∂ⁱⱼx_{out,s}ⁱ⁻¹

where

∂ⱼ⁽ⁱ⁾=(d_{qh}−x_{out,j}⁽ⁱ⁾)g(vⱼ⁽ⁱ⁾) for the hidden layers

∂ⱼ⁽ⁱ⁾=(Σ∂ₕ⁽ⁱ⁺¹⁾Wₕⱼⁱ⁺¹)g(vⱼ⁽ⁱ⁾) for the output layer (10)
Wⱼₛ=Weight of the connection between the neuron j in the i^{th} layer and neurons in the (i−1)^{th} layer.
g(vⱼ⁽ⁱ⁾)=First derivative of the neuronal activation function with respect to the input to i^{th} layer
h=Number of input/output patters.

The steps of the gradient descent algorithm comprise the following: (a) initializing weights to random values; (b) from the set of input/output pairs, presenting the input pattern to the network and calculating the output according to Equation (8); (c) comparing the desired output with the actual value to compute the error; (d) updating the weights of the network using Equation (10); and (e) repeating steps (a)-(d) until a pre-determined level of accuracy is reached.

Particle Swarm Optimization

Particle swarm optimization is a population based technique wherein the system is initialized with a population of networks, each with randomly initialized weights. The algorithm searches for the optima satisfying a defined performance index over generations, i.e., iterations, of training. Each neural network weight, referred to as a particle, is represented by a position vector lᵢ, where i=1,. . . ,n represents the number of network weights (particles) initialized.

The swarm of particles is flown through the solution space with a velocity defined by vector vᵢ. At each time step, the fitness of the population of networks is calculated using lᵢ as the input. Each particle tracks its best position, which is associated with the local best fitness it has achieved at any particular time step in a vector lbᵢ. Additionally, a global best fitness, i.e., a best position among all the particles at any particular time step, is tracked as gb.

At each time step t, by using the individual best position, lbᵢ(t), and the global best position, gb(t), a new velocity for the particle i is calculated by the equation,

vᵢ(t−1)=Ψ(vᵢ(t))+c₁φ₁(lbᵢ(t)−lᵢ(t))+c₂φ₂(gb(t)−lᵢ(t)) (11)

where,
vᵢ=Velocity of the particle
Ψ=Inertia factor
c₁ and c₂=Positive constants
φ₁ and φ₂=uniformly distributed random numbers between [0 1].

The velocity change of a particle, given by Equation (11), comprises three parts. The first part represents momentum and controls abrupt changes in velocity. The second part is the cognitive part, which can be considered as the intelligence of the particle, i.e., the particle's learning from its flying experience. The third part is the social part, which represents the collaboration of the particle with its neighbors. The balance among the three parts determines the balance of the global and local search ability, and therefore, the performance of the PSO.

The inertia factor controls the ability of the PSO to search locally and globally. The larger the value of inertia, the better the global search ability. Applicants have found preferable PSO parameters to be the following: inertia weight=0.8, c₁=0.8, c₂=0.5, and size of swarm=10. Based on the updated velocities, each particle's position is changed according to the equation,

lᵢ(t+1)=lᵢ(t)+vᵢ(t+1) (12)

where lᵢ is the position of particle in the search space.

Based on the above equations, the particles tend to cluster together with each particle moving in a random direction, thereby enhancing the searching ability by overcoming the premature convergence to a local minimum.

Evolutionary Algorithm

Evolutionary algorithms are a class of probabilistic adaptive algorithms that are devised on the principle of biological evolution. They are used to train neural networks because they provide a broad and global search procedure. They distinguish themselves from other algorithms by being a population based method, wherein each individual in the population represents a possible solution to the given problem. Each individual is assessed by a fitness score, namely the network's mean squared error (“MSE”), to determine the best fitting individual. The main operator used in this approach to EA is the mutation parameter. Mutation is inspired by the role of mutation of an organism's DNA in natural evolution. In this approach the best fitting individuals (parents) are chosen and they undergo mutation (to create offspring), which moves the search space to a different area in the solution space, thereby facilitating a better global search. EA has been shown to be a robust search algorithm that allows locating quickly the areas of high quality solutions, even if the search space is large and complex. The quality of EA that enables broader global searching makes it suitable for neural network training.

The EA comprises the following general steps: (a) defining a population of n neural networks, Nᵢ, i=1, 2, . . . , n, with randomly initialized weights and biases; (b) generating weights and biases by sampling from a uniform distribution over [−1, 1]; (c) applying a self adaptive parameter, σᵢ, i=1, . . . , n, to each individual network, where each component corresponds to a weight or bias and serves to control the step size of the search for new mutated parameters of the network; (d) for each parent, generating an offspring by varying the associated weights and biases; (e) calculating each network's fitness value, MSE, during each cycle of mutation; and (f) repeating steps (a)-(e) until a predetermined level of fitness is reached. Step (d) further includes the substeps of (d1) for each parent Nᵢ, creating an offspring N′ with weights calculated using the rule of mutation; and (d2) periodically making random changes or mutations in one or more members of the network assessed as the worst performing networks of the population, so as to yield a new network that may be better or worse than the current population of networks.

Although there are many possible ways to perform a mutation operation. embodiments of the present invention apply Equation (13) for generating new offspring from a segregated population of winners or networks with the best fitness. The values for the weights, W′(i), for a new network, N′, generated from an elite parent, N, due to mutation is generally small and is controlled by the self adaptive parameter σᵢ, provided in Equation (13).

σ′(i)=σ(i)e^{τN}^{ᵢ}^{(0,1)}, i=1,2, . . . , N_{w}

W′(i)=W(i)+σ′(i)Nᵢ(0,1), i=1,2, . . . , N_{w} (13)

where,

$$τ = \frac{1}{\sqrt{2 \sqrt{{N}_{w}}}} \qquad ( 14 )$$

N_{w}=Total number of weights and biases in the network
Nᵢ(0,1)=Standard Gaussian random variable re-sampled for every i.

Hybrid of Gradient Descent Algorithm, PSO, and EA

As noted above, PSO operates by analyzing the social and cognitive adaptation of knowledge; in contrast, the EA operates by evolving from generation to generation. The EA discards valuable information at the end of a generation, while PSO tracks in its memory the information of the local and global best solution throughout the process. The mutation property of EA assists in maintaining diversity in the PSO population by moving the search space to a different area of the solution space. The gradient descent algorithm assists in arriving at the closest minima of the error surface rapidly.

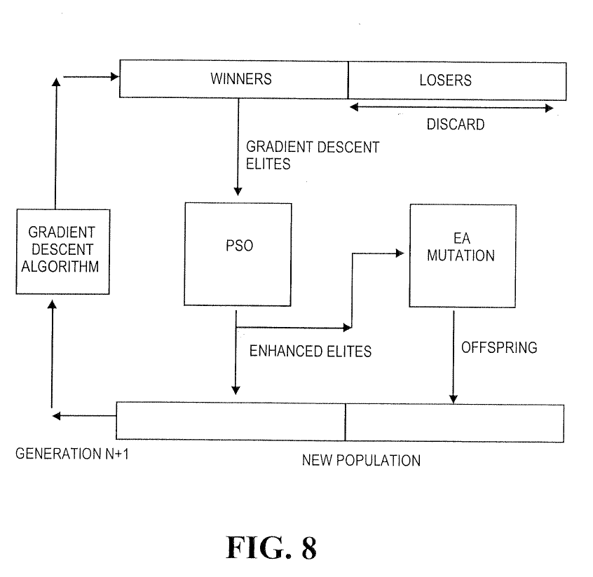

Based on the complementary properties of the three algorithms, embodiments of the present invention apply a hybrid algorithm, illustrated in FIG. 8. As briefly noted above, a population of ten neural networks is randomly initialized and each individual network is trained with the given input/output pattern. In each iteration, after the initial gradient descent learning, the winners from each network are chosen. The winners are the top 5 individuals with the best fitness, calculated based on the mean squared error (“MSE”) of the actual and desired values. The winners are then enhanced using the PSO. The other half of the population is discarded. The winners enhanced by the PSO are then run through the EA algorithm to create an equal number of individuals through mutation. This procedure enhances the entire population.

Results and Examples for Application of the Neural Network to Predict Valve Failure in the Reciprocating Compressor

Applicants conducted several tests to determine valve plate failure, spring failure, and stiction detection and prognostics using the algorithms discussed above. For both application of the logistic regression, discussed in detail below, and the neural network, the waveform was first decomposed, as noted above.

Application of WPT for Pressure Waveform Decomposition

The pressure waveform was subjected to a six level wavelet decomposition using the Daubechies (db4) wavelet as the wavelet function. The Debauchies wavelet is a compactly supported mother wavelet that defines the timing window for frequency analysis. It allows the wavelet transformation to efficiently represent functions or signals with localized features. Real-world signals, such as the valve pressure, have these localized features, and tools like a Fourier transform are not fully equipped to recognize these features. The property of compact support assists in applications such as compression, signal detection, and de-noising.

The pressure waveform at the cylinder outlet is analogous to the valve movement. Because it is a non-stationary waveform, it requires a time-frequency analysis for effective identification of fault pattern and failure diagnostics. A subset of twelve (12) prominent feature components based on wavelet energies was selected using the Fisher's criterion, as discussed above. These features, along with the temperature data, were further used for training the logistic regression model for normal and faulty operation mode detection, as discussed in more detail below.

Once the prominent feature components were selected, the neural network was trained. A hundred hours (100) of data was used to train the network in six hundred (600) minute increments. The network was designed to train with the latest six hundred (600) minutes of the data dynamically to predict the future trend of the wavelet feature one hundred twenty (120) minutes ahead from any given present time. The inputs to the model were an historic energy trend extracted by the wavelet transforms of the pressure signal, peak pressure value per cycle of compression, time to peak pressure per cycle of compression, and temperature data for six hundred (600) minutes, represented by Eₙ, Pₙ, Vₙ, and Tᵢ respectively. The outputs were the predicted trend of the wavelet features, represented by E₁, E₂, . . . , Eₙ, for the next one hundred twenty (120) minutes.

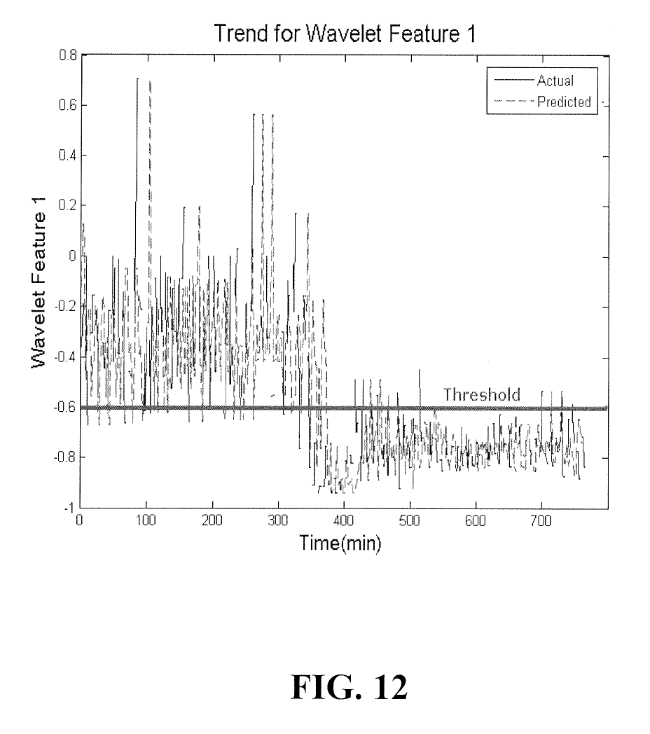

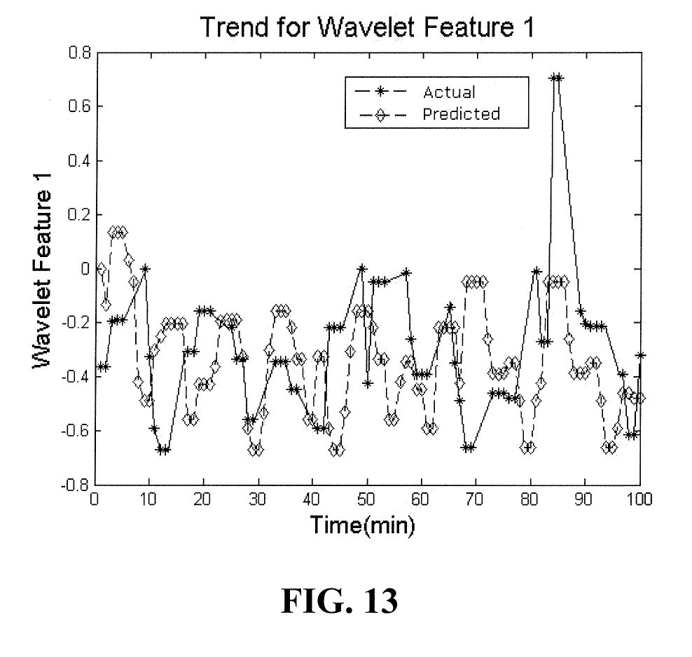

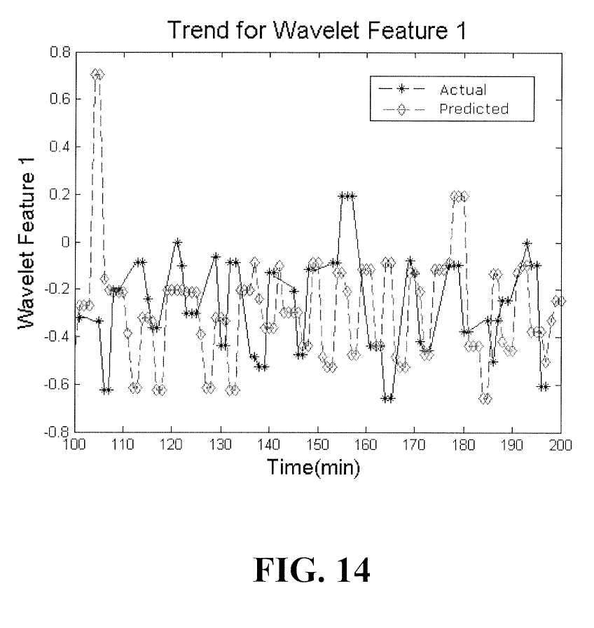

Before beginning the training process, the pressure and temperature data were normalized using the following equation:

$${inp}_{i} = ( \frac{{INP}_{i} - min ( {INP}_{i} )}{max ( {INP}_{i} ) - min ( {INP}_{i} )} - 0.5 ) * 1.90 \qquad ( 15 )$$

where INP is the matrix of the input data provided above. The normalization will smooth out the extreme outliers and insure that the values of the inputs to the neural network are between −0.95 and +0.95, which is the range of the neuronal activation function. The dynamic prediction results for the valve system are illustrated in FIG. 12. FIGS. 13 and 14 illustrate the prediction of the wavelet feature for the first two hundred (200) minutes.

The neural network is able to predict the trend of the wavelet features in close proximity to the actual values. A threshold value for the wavelet features needs to be established so that an alarm is triggered when the predicted trend crosses it. In the tests run by Applicants, the threshold value was set at −0.6 based on observations of previous failures and the mean value of the energy for normal operation. It is to be noted that the seeded failure on the testing platform was accelerated, which is to say that the time from the valve performance degradation to failure was also accelerated. In real-life failure scenarios, the time scale from degradation to failure is more gradual and is expanded. The neural network will be able to predict further ahead into the future under real-life scenarios. The neural network can be improved by including more system parameters into the training, such as vibration data.

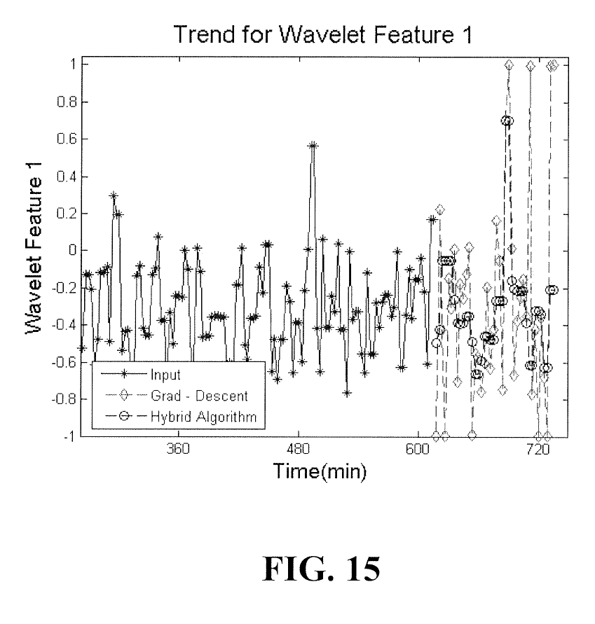

In order to check the performance and efficacy of the neural network of embodiments of the present invention, it was compared with the results of predictions using only the gradient descent algorithm for training the same neural network. FIG. 15 compares the predictions given by the hybrid model of embodiments of the present invention with a model that only uses the gradient descent algorithm. The plot in FIG. 15 illustrates that the input to the training model, depicted by ‘*’, and the predicted trend of the energy features, depicted by ‘⋄’ and ‘∘’ for the prior art gradient descent algorithm and the hybrid algorithm of the present invention, respectively. As seen in the plot, the hybrid algorithm used for training the neural network was shown to have better convergence and generality to function approximation.

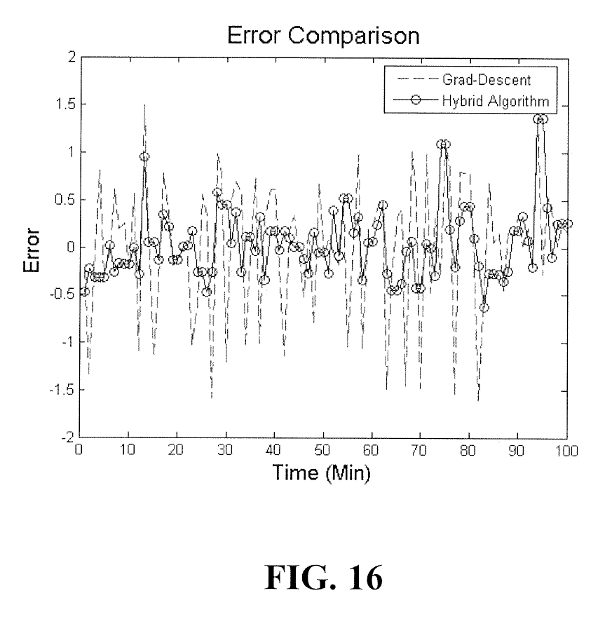

The plot in FIG. 16 illustrates the error in prediction between the actual and predicted values of energy trends for the two methods. The hybrid algorithm shows better approximation of the process, thereby enabling better prediction results as indicated by the error comparisons in FIG. 16. In contrast, the gradient descent algorithm provides acceptable results for short-term prediction, but has larger error for long-term prediction.

### Detection and Classification of Valve Failures Using Logistic Regression

Embodiments of the present invention are also operable to detect valve failure and provide a root cause analysis for the valve failure, i.e., why the valve failure occurred. In particular, Applicants have found that embodiments of the present invention have been shown to successfully classify stiction on valves with an accuracy of 98.2%, as described in more detail below. Further, Applicants have applied the present invention to successfully detect failure of the valve plate. To accomplish this detection, embodiments of the present invention train a logistic regression (“LR”) function or model to recognize failure modes. When trained effectively, the LR model can provide a probability of failure of a component of the valve, which can then be tracked for maintenance scheduling. Further, the LR model can be trained to recognize other failure modes, such as spring degradation.

The operation of the compressor system can be obtained from daily maintenance records and logs. The system operation is dichotomous, i.e., either the system is operating normally or it is broken (in failure). As noted above, how the system is operating, and the cause of any system failure, is determined by training the LR model. The goal of LR is to find the best fitting model to describe the relationship between a categorical characteristic of a dependent variable, i.e., the probability of an event constrained between 0 and 1, and a set of independent variables. Inputting of information into the LR “trains” the LR to determine the cause or “fault” of certain events, such as the system being broken, i.e., a failure.

The LR function is defined as:

$$P ( x ) = \frac{1}{1 + {e}^{- g ( x )}} = \frac{{e}^{g ( x )}}{1 + {e}^{g ( x )}} \qquad ( 16 )$$

where P(x) is defined as the probability of an event occurring.

The LR model g(x), which is a linear combination of independent variables x₁, x₂, . . . ,x_{K}, is given by

$$g ( x ) = log \frac{P ( x )}{1 - P ( x )} = α + {β}_{1} {x}_{1} + {β}_{2} {x}_{2} + … + {β}_{K} {x}_{K} \qquad ( 17 )$$

For estimating P(x), the parameters α and β₁,β_{2,} . . . ,β_{K} need to determined in advance. Estimation in LR chooses values of parameters of α and β₁,β_{2,} . . . ,β_{K} using the maximum likelihood method. Then, the probability of failure for each input vector x can be calculated according to Equation (16).

The LR thus allows an engineer to not only know when the system is operating or is in failure, which in most cases is self-evident, but to know the root cause of any system failures. As can be appreciated, embodiments of the present invention monitor certain known parameters of the compressor system, such as temperature and pressure. If the temperature, for example, fluctuates outside an acceptable range, the reason for the temperature fluctuation could be dependent on several different faults; however, the effect of the faults is the same, i.e., the temperature is fluctuation outside acceptable range. Application of the LR determines what type of fault is causing the failure.

Application of Logistic Regression on Pressure and Temperature Signatures for Fault Isolation

Performance assessment of the valve condition based on the pressure and temperature signatures is accomplished by training the LR model. To confirm successful application of the LR model of embodiments of the present invention, Applicants trained two LR models and tested both for detection of two failure conditions. One model was trained for detection of stiction on valve plates, and the other model was trained for detection of valve leak condition. The models showed good results in detection of both the faults on the valve.

In more detail, the LR model was trained with five thousand (5000) cases of valves under normal conditions and five thousand (5000) cases of valves under stiction. The inputs to the model were the wavelet packet features extracted from the pressure signals, as described above, and the temperature data.

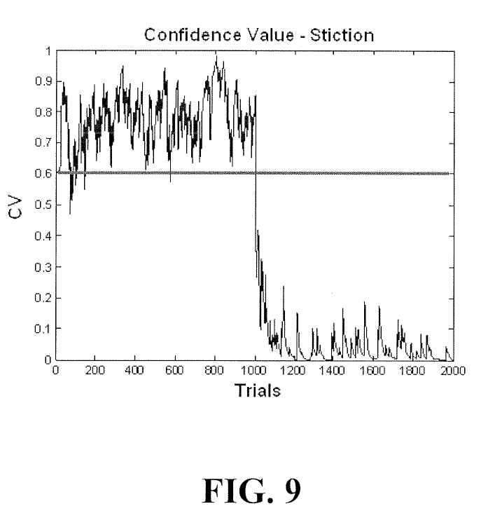

Two thousand (2000) cases (1000 normal and 1000 faulty) were then used to validate the trained LR model. The parameters α, β₁, β₂, . . . β_{K} were estimated using a maximum likelihood method to obtain the model for performance assessment. The confidence value (“CV”) was then calculated based on the probability of failure. CV is defined as CV=1−P(x). When the reciprocating compressor 10 is running normally, CV is close to 1. The CV of the reciprocating compressor 10 starts to fall towards zero as the compressor starts to fail. The closer the CV is to 0, the closer the compressor 10 is to failure. If the confidence value is less than a pre-determined threshold, for example 0.6, an alarm will be triggered indicating degradation due to failure of component. The CV plot for the test data is illustrated in FIG. 9. The following table provides the statistical inference from these data. As can be seen, embodiments of the LR model of the present invention detected failures with an accuracy of 98.2%.

Statistics of the Stiction Test

| | |
|---|---|
| Total Number of Trials Tested | 2000 |
| Number of trials tested for normal condition | 1000 |
| Error in classification (False Positives) | 1.3% |
| Number of trials tested for stiction condition | 1000 |
| Error in classification (False Negatives) | 0.50% |
| Percent of correct classifications | 98.2% |

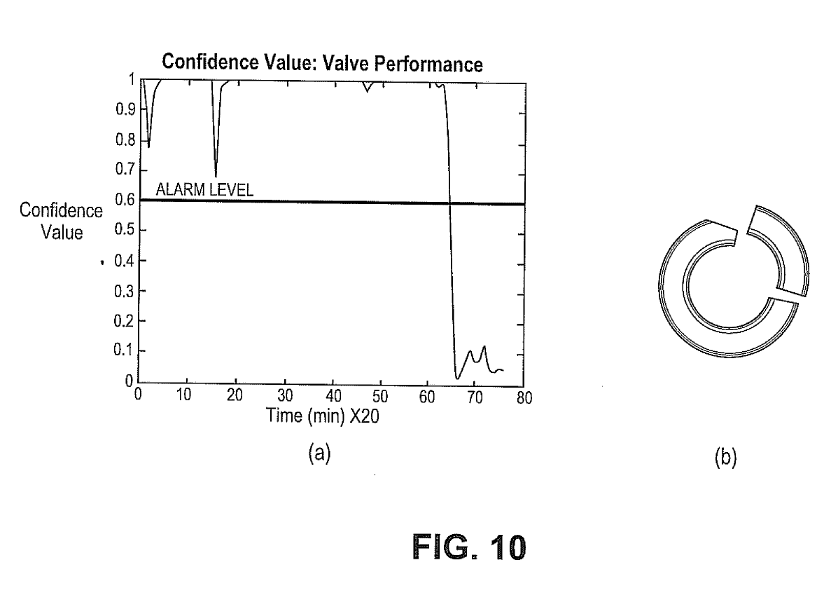

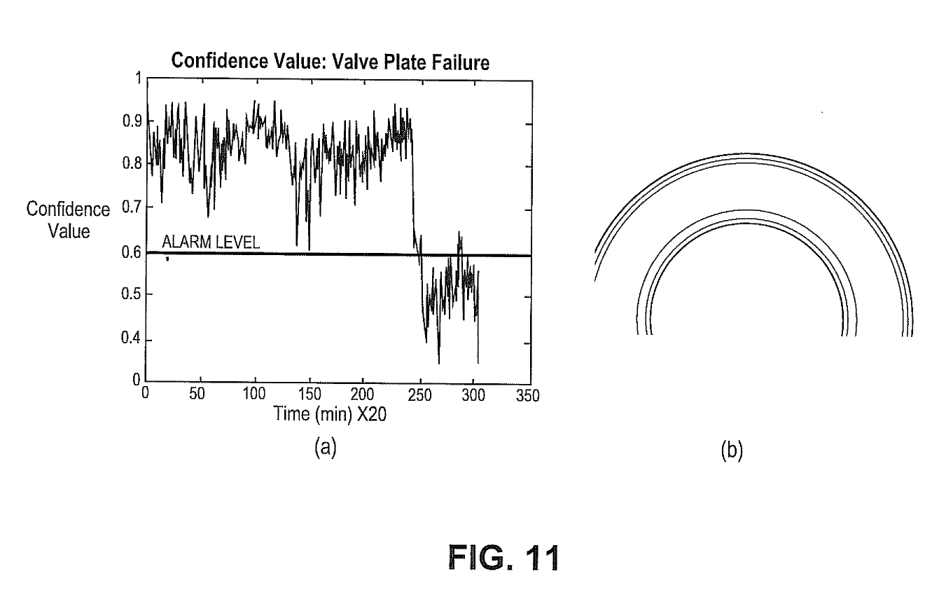

Applicants also ran the LR model to detect valve plate failure. In particular, three hundred (300) cycles of the reciprocating compressor 10 were used as training data, including two hundred fifty (250) normal cycles (P(x)=0) and fifty (50) faulty cycles (P(x)=1). The model was trained on one set of valve failure data and tested on another set. The plots of the failed components and their CV assessments from the LR model are illustrated in FIGS. 10 and 11.

FIG. 10 illustrates the implementation of the LR model for a total valve failure condition. The model was then used to determine the health of another valve plate failure, and those results are illustrated in FIG. 11. It is to be noted that the CV for the second failure was closer to the alarm level, as it was only a partial failure with a small crack on the valve plate. Hence, CV can be used as a quantitative measure of the failure.

The alarm level for the CV is set at 0.6, at which point an alarm will be triggered to indicate degradation in performance due to failure of the component. The trained LR model is also able to detect the degradation in performance failure of the valve plate when the CV drops beyond the alarm level.

Although embodiments of the invention have been described herein, it is noted that equivalents and substitutions may be employed without departing from the scope of the invention as recited in the claims.

Having thus described the embodiments of the invention, what is claimed as new and desired to be protected by Letters Patent includes the following:

We claim:

1. A computer program stored on a computer-readable medium for predicting failure of a valve in a reciprocating compressor, the computer program comprising:
a code segment executable by the computer for monitoring a pressure signal produced by the valve of the reciprocating compressor;
a code segment executable by the computer for applying a time-frequency analysis to the pressure signal so as to obtain a pressure waveform;
a code segment executable by the computer for applying a wavelet transform to the pressure waveform so as to perform a feature selection analysis; and
a code segment executable by the computer for training a plurality of neural networks so a s to select a best performing network operable to predict a behavior for the valve of the reciprocating compressor within a predetermined period of time, the code segment for training of the plurality of neural networks including
a code segment executable by the computer for initializing the plurality of neural networks by inputting a portion of the features selected from the feature selection analysis into each of the plurality of networks,
a code segment executable by the computer for applying a gradient descent algorithm to each neural network to obtain a generalized error of the neural network,
a code segment executable by the computer for selecting from each of the neural networks a plurality of high-performing networks,
a code segment executable by the computer for applying a particle swarm optimization to enhance an accuracy of the selected high-performing networks,
a code segment executable by the computer for creating an equal number of high-performing networks by mutating the high-performing networks selected from step (d3) using an evolutionary algorithm, and
a code segment executable by the computer for repeating the code segments for training of the plurality of neural networks until the plurality of neural networks are trained to have a predetermined accuracy rate between an actual value and a desired value.

2. The computer program as claimed in claim 1, wherein the pressure signal is monitored using a sensor operably connected with the reciprocating compressor and the computer.

3. The computer program as claimed in claim 1, wherein the valve is associated with a pressure, a temperature, a peak pressure value per a cycle of compression, and a time to peak pressure per a cycle of compression.

4. The computer program as claimed in claim 1, wherein application of the neural network is operable to predict an energy trend for the reciprocating compressor.

5. The computer program as claimed in claim 1, wherein the features selected are the wavelet energies obtained from application of the wavelet transform.

6. The computer program as claimed in claim 5, wherein the features selected are ranked according to a criterion function.

7. The computer program as claimed in claim 1, wherein the high-performing networks selected from step (d3) are selected based on a mean squared error of the actual and desired values for the network.

8. The computer program as claimed in claim 2, wherein the plurality of neural networks are trained in with approximately one hundred hours of pressure signals obtained from the sensor.

9. A method for detecting and identifying failure of a valve in a reciprocating compressor, the method comprising the steps of:
(a) monitoring a pressure signal produced by the valve of the reciprocating compressor;
(b) applying a time-frequency analysis to the pressure signal so as to obtain a pressure waveform;
(c) applying a wavelet transform to the pressure waveform so as to perform a feature selection analysis; and
(d) training a plurality of neural networks so as to select a best performing network operable to predict a behavior for the valve of the reciprocating compressor within a predetermined period of time, the training of the plurality of neural networks including the steps of
(d1) initializing the plurality of neural networks by inputting a portion of the features selected from the feature selection analysis of step (c) into each of the plurality of networks,
(d2) applying a gradient descent algorithm to each neural network to obtain a generalized error of the neural network,
(d3) selecting from each of the neural networks a plurality of high-performing networks,
(d4) applying a particle swarm optimization to enhance an accuracy of the selected high-performing networks,
(d5) creating an equal number of high-performing networks by mutating the high-performing networks selected from step (d3) using an evolutionary algorithm, and
(d6) repeating steps (d1)-(d5) until the plurality of neural networks are trained to have a predetermined accuracy rate between an actual value and a desired value.

10. The method as claimed in claim 9, wherein the pressure signal is monitored using a sensor operably connected with the reciprocating compressor.

11. The method as claimed in claim 9, wherein the valve is associated with a pressure, a temperature, a peak pressure value per a cycle of compression, and a time to peak pressure per a cycle of compression.

12. The method as claimed in claim 9, wherein application of the neural network is operable to predict an energy trend for the reciprocating compressor.

13. The method as claimed in claim 12, wherein the features selected are the wavelet energies obtained from application of the wavelet transform.

14. A computer program stored on a computer-readable medium for detecting and identifying failure of a valve in a reciprocating compressor, the computer program comprising:
a code segment executable by the computer for monitoring a pressure signal produced by the valve of the reciprocating compressor;
a code segment executable by the computer for monitoring a temperature signal produced by the valve of the reciprocating compressor;
a code segment executable by the computer for applying a time-frequency analysis to the pressure signal so as to obtain a pressure waveform;
a code segment executable by the computer for applying a wavelet transform to the pressure waveform so as to obtain a plurality of features;
a code segment executable by the computer for inputting the plurality of features into a logistic regression model; and
a code segment executable by the computer for obtaining from the logistic regression model a probability of valve failure.

15. The computer program as claimed in claim 14, wherein the pressure and temperature signals are monitored using at least one sensor operably connected with the reciprocating compressor and the computer.

16. The computer program as claimed in claim 14, wherein the logistic regression model is defined as:
$$P ( x ) = \frac{1}{1 + {e}^{- g ( x )}} = \frac{{e}^{g ( x )}}{1 + {e}^{g ( x )}}$$

17. The computer program as claimed in claim 14, wherein an efficacy of identifying failure of the valve was within the range of approximately 90%-99%.
